(19) United States
(12) Patent Application Publication
(10) Pub. No.: US 2024/0022827 A1
(43) Pub. Date: Jan. 18, 2024

(54) HIGH DYNAMIC RANGE (HDR) PHOTOGRAPHY USING MULTIPLE FRAME RATES

(71) Applicant: QUALCOM Incorporated, San Diego, CA (US)

(72) Inventors: Nitin Srivastava, Hyderabad (IN); Prakasha Nayak, Parkala (IN); Rahul Kumar, Hyderabad (IN); Saurabh Aggarwal, Faridkot (IN); Alok Kumar Pandey, Hyderabad (IN)

(21) Appl. No.: 17/812,635

(22) Filed: Jul. 14, 2022

(51) Int. Cl. H04N 5/235; H04N 5/355; H04N 5/232

(52) U.S. Cl. CPC H04N 5/2355; H04N 5/35581; H04N 5/23232

(57) ABSTRACT

This disclosure provides systems, methods, and devices for image capture and image process that support staggered high dynamic range (HDR) using image frames captured at different frame rates. In a first aspect, a method of image capture includes configuring a camera for image capture at a first frame rate; receiving, from the camera, first image data captured at the first frame rate; configuring the camera for image capture at a second frame rate higher than the first frame rate; receiving, from the camera, second image data captured at the second frame rate; and determining at least one output image frame based on the first image data and the second image data. Other aspects and features are also claimed and described.

### TECHNICAL FIELD

Aspects of the present disclosure relate generally to image processing, and more particularly, to capturing and processing image data. Some features may enable and provide improved image processing, including improved dynamic range in video and photography.

### INTRODUCTION

Image capture devices are devices that can capture one or more digital images, whether still image for photos or sequences of images for videos. Capture devices can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computer devices such as webcams, video surveillance cameras, or other devices with digital imaging or video capabilities.

Dynamic range may be important to image quality when capturing a representation of a scene with a wide color gamut using an image capture device. Conventional image sensors have a limited dynamic range, which may be smaller than the dynamic range of human eyes. Dynamic range may refer to the light range between bright portions of an image and dark portions of an image. A conventional image sensor may increase an exposure time to improve detail in dark portions of an image at the expense of saturating bright portions of an image. Alternatively, a conventional image sensor may decrease an exposure time to improve detail in bright portions of an image at the expense of losing detail in dark portions of the image. Thus, image capture devices conventionally balance conflicting desires, preserving detail in bright portions or dark portions of an image, by adjusting exposure time. High dynamic range (HDR) photography improves photography using these image sensors by combining multiple recorded representations of a scene from the image sensor.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In some aspects, high dynamic range (HDR) image frames for use in photography and video may be generated from multiple representations recorded representations of a scene from the image sensor, in which the multiple representation are captured with the image sensor configured for different frame rates. The different frame rates result in capturing the scene with different exposure times because the capture time for a frame is proportional to the frame rate.

In one example embodiment, long frames are captured in a 30 FPS mode, which corresponds to an exposure time as high as 33 ms. Capturing dark scenes with high exposure time (e.g., up to 33 ms) provides higher sensitivity and thus more pixel information, which increases the dynamic range. Short frames are captured immediately after the long frame by switching the image sensor mode to a higher FPS mode of, for example, 60 or 90 FPS, which results in capturing 2 or 3 frames within the same 33 ms time as the long frame. Short frame interval can be tuned based on motion in the scene being captured. Long and short frames captured are fused together to output a single frame for display, transmission, storage, or further processing.

In one aspect of the disclosure, a method for image processing includes configuring a camera for image capture at a first frame rate; receiving, from the camera, first image data captured at the first frame rate; configuring the camera for image capture at a second frame rate higher than the first frame rate; receiving, from the camera, second image data captured at the second frame rate; and determining at least one output image frame based on the first image data and the second image data.

In an additional aspect of the disclosure, an apparatus includes at least one processor and a memory coupled to the at least one processor. The at least one processor is configured to perform steps including configuring a camera for image capture at a first frame rate; receiving, from the camera, first image data captured at the first frame rate; configuring the camera for image capture at a second frame rate higher than the first frame rate; receiving, from the camera, second image data captured at the second frame rate; and determining at least one output image frame based on the first image data and the second image data.

In an additional aspect of the disclosure, an apparatus includes means for configuring a camera for image capture at a first frame rate; means for receiving, from the camera, first image data captured at the first frame rate; means for configuring the camera for image capture at a second frame rate higher than the first frame rate; means for receiving, from the camera, second image data captured at the second frame rate; and means for determining at least one output image frame based on the first image data and the second image data.

In an additional aspect of the disclosure, a non-transitory computer-readable medium stores instructions that, when executed by a processor, cause the processor to perform operations. The operations include configuring a camera for image capture at a first frame rate; receiving, from the camera, first image data captured at the first frame rate; configuring the camera for image capture at a second frame rate higher than the first frame rate; receiving, from the camera, second image data captured at the second frame rate; and determining at least one output image frame based on the first image data and the second image data.

Image capture devices, devices that can capture one or more digital images whether still image photos or sequences of images for videos, can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computer devices such as webcams, video surveillance cameras, or other devices with digital imaging or video capabilities.

In general, this disclosure describes image processing techniques involving digital cameras having image sensors and image signal processors (ISPs). The ISP may be configured to control the capture of image frames from one or more image sensors and process one or more image frames from the one or more image sensors to generate a view of a scene in a corrected image frame. A corrected image frame may be part of a sequence of image frames forming a video sequence. The video sequence may include other image frames received from the image sensor or other images sensors and/or other corrected image frames based on input from the image sensor or another image sensor. In some embodiments, the processing of one or more image frames may be performed within the image sensor. The image processing techniques described in embodiments disclosed herein may be performed by circuitry in the image sensor, in the image signal processor (ISP), in the application processor (AP), or a combination or two or all of these components.

In an example, the image signal processor may receive an instruction to capture a sequence of image frames in response to the loading of software, such as a camera application, to produce a preview display from the image capture device. The image signal processor may be configured to produce a single flow of output frames, based on images frames received from one or more image sensors. The single flow of output frames may include raw image data from an image sensor or corrected image frames processed by one or more algorithms within the image signal processor. For example, an image frame obtained from an image sensor, which may have performed some processing on the data before output to the image signal processor may be processed in the image signal processor by processing the image frame through an image post-processing engine (IPE) and/or other image processing circuitry for performing one or more of tone mapping, portrait lighting, contrast enhancement, gamma correction, etc.

After an output frame representing the scene is determined by the image signal processor using the image correction described in various embodiments herein, the output frame may be displayed on a device display as a single still image and/or as part of a video sequence, saved to a storage device as a picture or a video sequence, transmitted over a network, and/or printed to an output medium. For example, the image signal processor may be configured to obtain input frames of image data (e.g., pixel values) from the different image sensors, and in turn, produce corresponding output frames of image data (e.g., preview display frames, still-image captures, frames for video, etc.). In other examples, the image signal processor may output frames of the image data to various output devices and/or camera modules for further processing, such as for 3A parameter synchronization (e.g., automatic focus (AF), automatic white balance (AWB), and automatic exposure control (AEC)), producing a video file via the output frames, configuring frames for display, configuring frames for storage, transmitting the frames through a network connection, etc. That is, the image signal processor may obtain incoming frames from one or more image sensors, each coupled to one or more camera lenses, and, in turn, may produce and output a flow of output frames to various output destinations. In such examples, the image signal processor may be configured to produce a flow of output frames that may have improved appearance in low-light conditions.

In some aspects, the corrected image frame may be produced by combining aspects of the image correction of this disclosure with other computational photography techniques such as high dynamic range (HDR) photography or multi-frame noise reduction (MFNR). With HDR photography, the first image frame and a second image frame are captured using different exposure times, different apertures, different lenses, and/or other characteristics that may result in improved dynamic range of a fused image when the two image frames are combined. In some aspects, the method may be performed for MFNR photography in which the first image frame and a second image frame are captured using the same or different exposure times and fused to generate a corrected first image frame with reduced noise compared to the captured first image frame.

In some aspects, a device may include an image signal processor or a processor (e.g., an application processor) including specific functionality for camera controls and/or processing, such as enabling or disabling the image correction or otherwise controlling aspects of the image correction, such as by determining when to apply deblurring and applying a deblurring operation to a blurry object and controlling a zoom level of a resulting image. The methods and techniques described herein may be entirely performed by the image signal processor or a processor, or various operations may be split between the image signal processor and a processor, and in some aspects split across additional processors.

The apparatus may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a tele image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur with a lens cluster on a mobile device, such as where multiple image sensors and associated lenses are located in offset locations on a frontside or a backside of the mobile device. Additional image sensors may be included with larger, smaller, or same field of views. The image correction techniques described herein may be applied to image frames captured from any of the image sensors in a multi-sensor device.

In an additional aspect of the disclosure, a device configured for image processing and/or image capture is disclosed. The apparatus includes means for capturing image frames. The apparatus further includes one or more means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), time of flight detectors. The apparatus may further include one or more means for accumulating and/or focusing light rays into the one or more image sensors (including simple lenses, compound lenses, spherical lenses, and non-spherical lenses). These components may be controlled to capture the first and/or second image frames input to the image processing techniques described herein.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos in as a recording or as streaming data, over a first network connection of a plurality of network connections; and a processor coupled to the first network adaptor, and the memory. The processor may cause the transmission of corrected image frames described herein over a wireless communications network such as a 5G NR communication network.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of an example device 100 for performing image capture from one or more image sensors.

FIG. 2 is a block diagram illustrating the use of frames captured at two different frame rates to capture HDR photography according to some embodiments of the disclosure.

FIG. 3 is a flow chart illustrating an example method for determining output image frames from images captured at different frame rates according to some embodiments of the disclosure.

FIG. 4 shows a block diagram of an example device for performing an image capture operation in a device according to some embodiments of the disclosure.

FIG. 5 is a flow chart illustrating an example high dynamic range (HDR) operating mode for an image capture device to capture image frames with three exposure settings according to some embodiments of the disclosure.

FIG. 6 is a block diagram illustrating the use of frames captured at two different frame rates to perform HDR photography according to some embodiments of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support capturing long exposure frames and fusing one or more long exposure frames with multiple short exposure frames captured at different exposure durations. The different exposure durations may be obtained by controlling a frame rate of the camera to switch between a first frame rate for capturing one or more long image frames and a second frame rate for capturing two or more short image frames. The combination of long image frames and short image frames may be processed to determine output image frames that achieve a video sequence at a desired frame rate, which may be the lower of the first frame rate and the second frame rate.

Particular implementations of the subject matter described in this disclosure may be implemented to realize one or more of the following potential advantages or benefits. In some aspects, the present disclosure provides techniques for improved photography and video capture. For example, photographs may be obtained with increased dynamic range (DR) by allowing capture of a long exposure frame at a duration that is up to the maximum frame duration allowed at the corresponding frame rate, but also allow flexibility in shortening exposure within the frame duration to as low as a minimum exposure time for a camera configuration. Also, the dynamic range (DR) may be improved through the combination of three different exposure frames when fusing images to determine an output image frame.

An example device for capturing image frames using one or more image sensors, such as a smartphone, may include a configuration of two, three, four, or more cameras on a backside (e.g., a side opposite a user display) or a front side (e.g., a same side as a user display) of the device. Devices with multiple image sensors include one or more image signal processors (ISPs), Computer Vision Processors (CVPs) (e.g., AI engines), or other suitable circuitry for processing images captured by the image sensors. The one or more image signal processors may provide processed image frames to a memory and/or a processor (such as an application processor, an image front end (IFE), an image processing engine (IPE), or other suitable processing circuitry) for further processing, such as for encoding, storage, transmission, or other manipulation.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any electronic device including or coupled to two or more image sensors capable of capturing image frames (or “frames”). Further, aspects of the present disclosure may be implemented in devices having or coupled to image sensors of the same or different capabilities and characteristics (such as resolution, shutter speed, sensor type, and so on). Further, aspects of the present disclosure may be implemented in devices for processing image frames, whether or not the device includes or is coupled to the image sensors, such as processing devices that may retrieve stored images for processing, including processing devices present in a cloud computing system.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

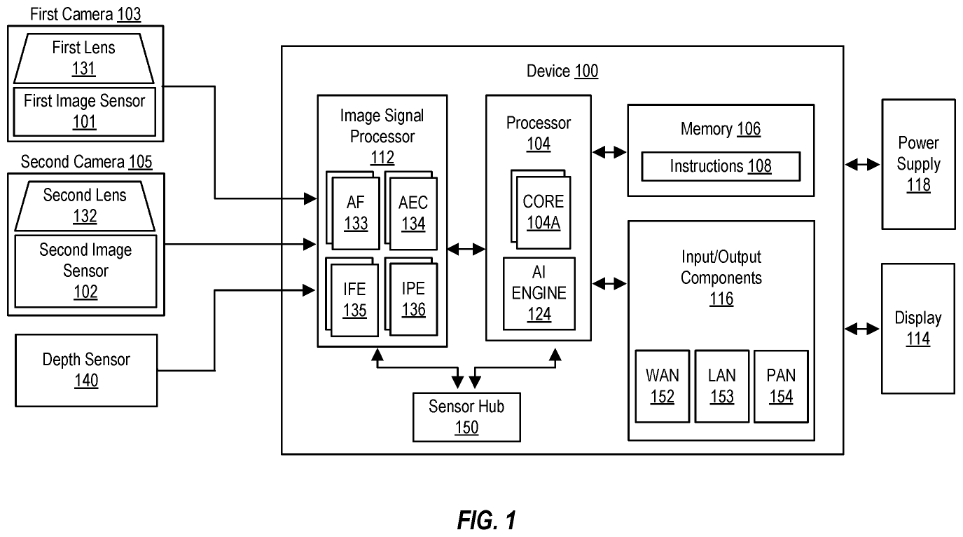

FIG. 1 shows a block diagram of an example device 100 for performing image capture from one or more image sensors. The device 100 may include, or otherwise be coupled to, an image signal processor 112 for processing image frames from one or more image sensors, such as a first image sensor 101, a second image sensor 102, and a depth sensor 140. In some implementations, the device 100 also includes or is coupled to a processor 104 and a memory 106 storing instructions 108. The device 100 may also include or be coupled to a display 114 and input/output (I/O) components 116. I/O components 116 may be used for interacting with a user, such as a touch screen interface and/or physical buttons. I/O components 116 may also include network interfaces for communicating with other devices, including a wide area network (WAN) adaptor 152, a local area network (LAN) adaptor 153, and/or a personal area network (PAN) adaptor 154. An example WAN adaptor is a 4G LTE or a 5G NR wireless network adaptor. An example LAN adaptor 153 is an IEEE 802.11 WiFi wireless network adapter. An example PAN adaptor 154 is a Bluetooth wireless network adaptor. Each of the adaptors 152, 153, and/or 154 may be coupled to an antenna, including multiple antennas configured for primary and diversity reception and/or configured for receiving specific frequency bands. The device 100 may further include or be coupled to a power supply 118 for the device 100, such as a battery or a component to couple the device 100 to an energy source. The device 100 may also include or be coupled to additional features or components that are not shown in FIG. 1. In one example, a wireless interface, which may include a number of transceivers and a baseband processor, may be coupled to or included in WAN adaptor 152 for a wireless communication device. In a further example, an analog front end (AFE) to convert analog image frame data to digital image frame data may be coupled between the image sensors 101 and 102 and the image signal processor 112.

The device may include or be coupled to a sensor hub 150 for interfacing with sensors to receive data regarding movement of the device 100, data regarding an environment around the device 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In some aspects, a gyroscope in an electronic image stabilization system (EIS) may be coupled to the sensor hub or coupled directly to the image signal processor 112. In another example, a non-camera sensor may be a global positioning system (GPS) receiver.

The image signal processor 112 may receive image data, such as used to form image frames. In one embodiment, a local bus connection couples the image signal processor 112 to image sensors 101 and 102 of a first and second camera, respectively. In another embodiment, a wire interface couples the image signal processor 112 to an external image sensor. In a further embodiment, a wireless interface couples the image signal processor 112 to the image sensor 101, 102.

The first camera may include the first image sensor 101 and a corresponding first lens 131. The second camera may include the second image sensor 102 and a corresponding second lens 132. Each of the lenses 131 and 132 may be controlled by an associated autofocus (AF) algorithm 133 executing in the ISP 112, which adjust the lenses 131 and 132 to focus on a particular focal plane at a certain scene depth from the image sensors 101 and 102. The AF algorithm 133 may be assisted by depth sensor 140.

The first image sensor 101 and the second image sensor 102 are configured to capture one or more image frames. Lenses 131 and 132 focus light at the image sensors 101 and 102, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging. The first lens 131 and second lens 132 may have different field of views to capture different representations of a scene. For example, the first lens 131 may be an ultra-wide (UW) lens and the second lens 132 may be a wide (W) lens. The multiple image sensors may include a combination of ultra-wide (high field-of-view (FOV)), wide, tele, and ultra-tele (low FOV) sensors. That is, each image sensor may be configured through hardware configuration and/or software settings to obtain different, but overlapping, field of views. In one configuration, the image sensors are configured with different lenses with different magnification ratios that result in different fields of view. The sensors may be configured such that a UW sensor has a larger FOV than a W sensor, which has a larger FOV than a T sensor, which has a larger FOV than a UT sensor. For example, a sensor configured for wide FOV may capture fields of view in the range of 64-84 degrees, a sensor configured for ultra-side FOV may capture fields of view in the range of 100-140 degrees, a sensor configured for tele FOV may capture fields of view in the range of 10-30 degrees, and a sensor configured for ultra-tele FOV may capture fields of view in the range of 1-8 degrees.

The image signal processor 112 processes image frames captured by the image sensors 101 and 102. While FIG. 1 illustrates the device 100 as including two image sensors 101 and 102 coupled to the image signal processor 112, any number (e.g., one, two, three, four, five, six, etc.) of image sensors may be coupled to the image signal processor 112. In some aspects, depth sensors such as depth sensor 140 may be coupled to the image signal processor 112 and output from the depth sensors processed in a similar manner to that of image sensors 101 and 102. In addition, any number of additional image sensors or image signal processors may exist for the device 100.

In some embodiments, the image signal processor 112 may execute instructions from a memory, such as instructions 108 from the memory 106, instructions stored in a separate memory coupled to or included in the image signal processor 112, or instructions provided by the processor 104. In addition, or in the alternative, the image signal processor 112 may include specific hardware (such as one or more integrated circuits (ICs)) configured to perform one or more operations described in the present disclosure. For example, the image signal processor 112 may include one or more image front ends (IFEs) 135, one or more image post-processing engines 136 (IPEs), and/or one or more auto exposure compensation (AEC) 134 engines. The AF 133, AEC 134, IFE 135, IPE 136 may each include application-specific circuitry, be embodied as software code executed by the ISP 112, and/or a combination of hardware within and software code executing on the ISP 112. The ISP 112 may additionally execute an automatic white balancing (AWB) engine for performing white balancing operations. The AWB engine may execute in, for example, the image front ends (IFEs) 135 or other dedicated or general processing circuitry within the ISP 112 or the image capture device 100, such as on a digital signal processor (DSP).

In some implementations, the memory 106 may include a non-transient or non-transitory computer readable medium storing computer-executable instructions 108 to perform all or a portion of one or more operations described in this disclosure. In some implementations, the instructions 108 include a camera application (or other suitable application) to be executed by the device 100 for generating images or videos. The instructions 108 may also include other applications or programs executed by the device 100, such as an operating system and specific applications other than for image or video generation. Execution of the camera application, such as by the processor 104, may cause the device 100 to generate images using the image sensors 101 and 102 and the image signal processor 112. The memory 106 may also be accessed by the image signal processor 112 to store processed frames or may be accessed by the processor 104 to obtain the processed frames. In some embodiments, the device 100 does not include the memory 106. For example, the device 100 may be a circuit including the image signal processor 112, and the memory may be outside the device 100. The device 100 may be coupled to an external memory and configured to access the memory for writing output frames for display or long-term storage. In some embodiments, the device 100 is a system on chip (SoC) that incorporates the image signal processor 112, the processor 104, the sensor hub 150, the memory 106, and input/output components 116 into a single package.

In some embodiments, at least one of the image signal processor 112 or the processor 104 executes instructions to perform various operations described herein, including noise reduction operations. For example, execution of the instructions can instruct the image signal processor 112 to begin or end capturing an image frame or a sequence of image frames, in which the capture includes noise reduction as described in embodiments herein. In some embodiments, the processor 104 may include one or more general-purpose processor cores 104A capable of executing scripts or instructions of one or more software programs, such as instructions 108 stored within the memory 106. For example, the processor 104 may include one or more application processors configured to execute the camera application (or other suitable application for generating images or video) stored in the memory 106.

In executing the camera application, the processor 104 may be configured to instruct the image signal processor 112 to perform one or more operations with reference to the image sensors 101 or 102. For example, the camera application may receive a command to begin a video preview display upon which a video comprising a sequence of image frames is captured and processed from one or more image sensors 101 or 102. Image correction, such as with cascaded IPEs, may be applied to one or more image frames in the sequence. Execution of instructions 108 outside of the camera application by the processor 104 may also cause the device 100 to perform any number of functions or operations. In some embodiments, the processor 104 may include ICs or other hardware (e.g., an artificial intelligence (AI) engine 124) in addition to the ability to execute software to cause the device 100 to perform a number of functions or operations, such as the operations described herein. In some other embodiments, the device 100 does not include the processor 104, such as when all of the described functionality is configured in the image signal processor 112.

In some embodiments, the display 114 may include one or more suitable displays or screens allowing for user interaction and/or to present items to the user, such as a preview of the image frames being captured by the image sensors 101 and 102. In some embodiments, the display 114 is a touch-sensitive display. The I/O components 116 may be or include any suitable mechanism, interface, or device to receive input (such as commands) from the user and to provide output to the user through the display 114. For example, the I/O components 116 may include (but are not limited to) a graphical user interface (GUI), a keyboard, a mouse, a microphone, speakers, a squeezable bezel, one or more buttons (such as a power button), a slider, a switch, and so on.

While shown to be coupled to each other via the processor 104, components (such as the processor 104, the memory 106, the image signal processor 112, the display 114, and the I/O components 116) may be coupled to each another in other various arrangements, such as via one or more local buses, which are not shown for simplicity. While the image signal processor 112 is illustrated as separate from the processor 104, the image signal processor 112 may be a core of a processor 104 that is an application processor unit (APU), included in a system on chip (SoC), or otherwise included with the processor 104. While the device 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

Image capture devices, such as the device described with reference to FIG. 1, may operate to capture image data at two or more different frame rates and merge the different-frame-rate data into a high dynamic range (HDR) image frame having improved dynamic range (DR) over image data captured at either a first frame rate or a higher second frame rate alone. Capturing image data at two different frames results in “long frames” corresponding to image frames formed from data captured at low frame rates and “short frames” corresponding to image frames formed from data captured at high frame rates. In some embodiments, long frames may be captured in a 30 frames per second (FPS) mode having a frame exposure time of 33 ms. This is a longer exposure time than available in conventional staggered high dynamic range (sHDR) because conventionally the multiple frames of a HDR image capture are obtained during the time of a single frame such that the frame exposure time is limited to less than 33 ms. Capturing dark scenes with higher exposure time (e.g., 33 ms in some embodiments of this disclosure compared to only a portion of 33 ms in conventional sHDR image capture) provides more pixel information and increases the dynamic range of the resulting HDR image frames. Short frames may be captured immediately after the long frame by switching a sensor mode to a higher FPS mode (e.g., 60 or 90 FPS, in which 2 or 3 frames, respectively, are captured within the 33 ms frame exposure time). Two or more short frames may be captured in equal or unequal intervals with different exposure times within 33 ms time frame. Short frame and/or long frame duration may be tuned based on motion in the scene being captured. Long and short frames may be fused together to provide a single output frame (e.g., a high dynamic range (HDR) image frame) as output.

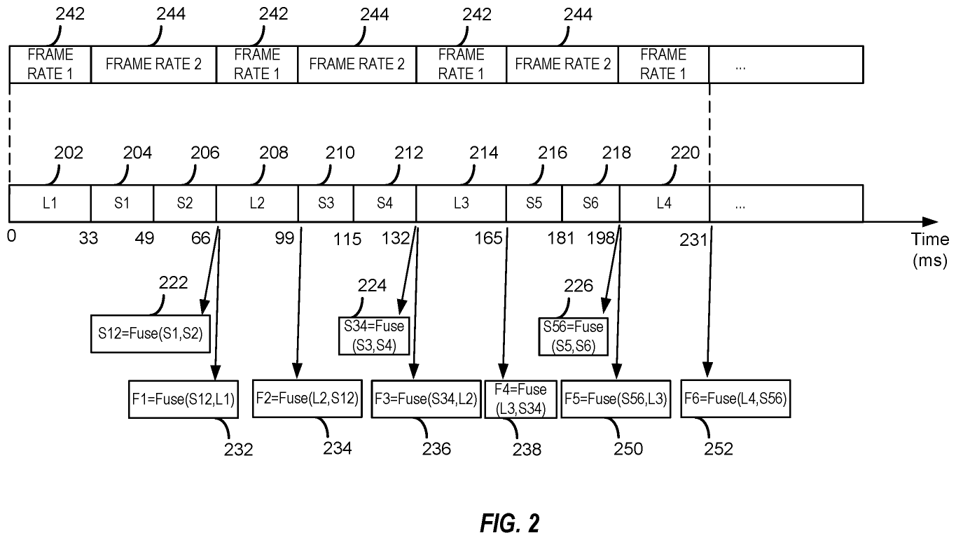

FIG. 2 is a block diagram illustrating the use of frames captured at two different frame rates to capture HDR photography according to some embodiments of the disclosure. A timeline of image frame capture from a camera is shown to include image frames 202-220. Image frames 202, 208, 214, and 220 correspond to image frames captured at lower frame rates, which may have longer durations. In some embodiments, the lower frame rate may be 30 FPS, corresponding to frame durations of 33 msec, although other frame rates may be used in different embodiments. Image frames 204, 206, 210, 212, 216, and 218 correspond to image frames captured at higher frame rates, which may have shorter durations. In some embodiments, the higher frame rate may be 60 FPS, corresponding to frame durations of 16 msec, although other frames rates (e.g., 90 FPS) may be used in different embodiments. In some embodiments, a frame exposure duration may be shorter than the duration corresponding to a frame at the configured frame rate. For example, image frame 202 may be captured with an exposure duration shorter than 33 ms, although the image sensor is configured for capture at a frame rate of 30 FPS. In another example, image frames 204 and 206 may be captured at different exposures with each less than or equal to the image frame duration.

Image processing may combine image data from long image frames 202, 208, 214, and 220 (also labeled as L1, L2, L3, L4) with image data from short image frames 204, 206, 210, 212, 216, and 218 (also labeled as S1, S2, S3, S4, S5, S6). The combining of long image frames and short image frames may improve the dynamic range of an output image frame determined from the long and short image frames. For example, the long image frame may obtain detail in lower light portions of a scene than conventionally possible in photography. The long image frame allows an exposure at a duration up to the maximum frame time at the configured frame rate, rather than being limited to a portion of the maximum frame time at the configured frame rate when multiple image frames are read out during one cycle.

The different duration image frame capture times between long image frames 202, 208, 214, and 220 and short image frames 204, 206, 210, 212, 216, and 218 may be achieved by changing a frame rate configuration of the camera capturing the image frames 202-220. For example, during capture of image frame 202, the image sensor in the camera is configured with a first image sensor configuration specifying a first frame rate 242. Subsequent image frames 204 and 206 may be captured with the image sensor in the camera configured with a second image sensor configuration 244 specifying a second frame rate. Multiple image frames may be captured at the faster frame rate with shorter frame durations such that the time the camera is set with the first image sensor configuration and the second image sensor configuration are equal. In some embodiments, the time that an image sensor is configured for different frame rates is unequal.

One technique for combining the image frames 202-220 to determine output image frames includes fusing subsequent short image frames to form an intermediate image frame, that intermediate image frame is then fused with a corresponding (e.g., adjacent) long image frame. For example, the multiple image frames captured at the higher frame rate may be combined to form an intermediate image frame 222. The intermediate image frame 222 (S12) may be the output of fusing the image frames 204 (S1) and 206 (S2), such that S12=Fuse(S1,S2). An output image frame 232 (F1) may be determined from the intermediate image frame 222 (S12) and the image frame 202 (L1), such that F1=Fuse(S12,L1).

Subsequent output image frames may be determined in a similar manner from additional image data. For example, a subsequent image capture may capture long image frame 208 (L2), short image frame 210 (S3), and short image frame 212 (S4). The next output image frame (F2) may be determined based on an intermediate image frame S34=Fuse(S3,S4), which is then fused with L2, such that F2=Fuse(S34,L2).

In some embodiments, additional output image frames may be generated by reusing intermediate image frame 222 (S12) for fusion with both adjacent long image frames. For example, output image frame 232 is determined by combining intermediate image frame 222 with long image frame 202 that precedes (such as adjacent to or immediately preceding in time) capture of image frames 204 and 206. Output image frame 234 may be determined by combining the intermediate image frame 222 with long image frame 208 that follows (such as adjacent to or immediately subsequent in time) capture of image frames 204 and 206. The subsequent output image frame 234 (F2) may be determined such that F2=Fuse(L2,S12). The sequence of output image frames 232 and 234 (F1 and F2) may repeat as additional sets of long and short image frames are captured. For example, image frames 210 and 212 (S3 and S4) may be captured, fused to form an intermediate image frame 224, such as from S34=Fuse(S3,S4), and output image frames 236 and 238 (F3 and F4) determined from the intermediate image frame 224 and either long image frame 208 (L2) or long image frame 214 (L3). The sequence may again repeat with short image frames 216 and 218 (S5 and S6) captured, fused to form an intermediate image frame 226, such as S56=Fuse(S5,S6), and output image frames 250 and 252 (F5 and F6) determined from intermediate image frame 226 and either long image frame 214 (L3) or long image frame 220 (L4). As additional sequences are performed, the image sensor may be switched between the first image sensor configuration specifying the first frame rate 242 and the second image sensor configuration specifying the second frame rate 244. The additional output image frames captured in this process may provide additional frames in a sequence of frames (e.g., F1, F2, F3, F4), which may reduce motion artifacts and improve smoothness in a video sequence formed from the output image frames. Such a video sequence may be used, for example, as a preview display in a camera application executing on a mobile device functioning as an image capture device. The sequence of frames may be compiled to form a video sequence at the same frame rate as the first frame rate 242 used to capture the long image frames 202, 208, 214, 220.

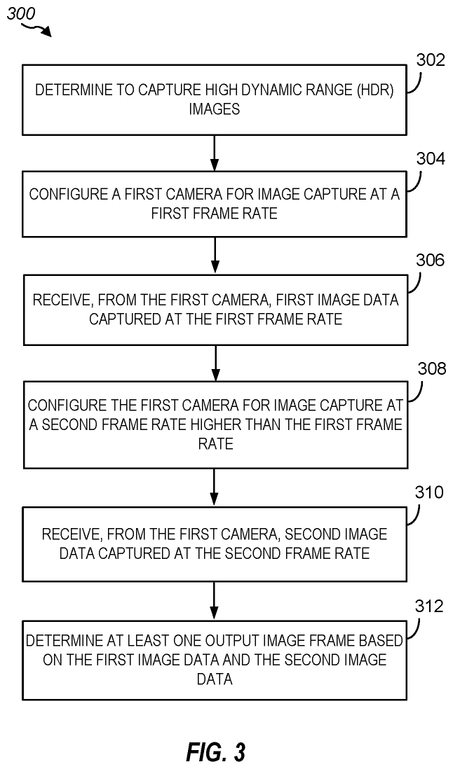

A method for performing image capture at different frames rates for high dynamic range (HDR) operation is described with reference to FIG. 3. FIG. 3 is a flow chart illustrating an example method for determining output image frames from images captured at different frame rates according to some embodiments of the disclosure. A method 300 may include, at block 302, determining to capture high dynamic range (HDR) image frames. The determination may be based on detecting a wide color gamut or wide dynamic range in an image captured in a standard dynamic range (SDR) mode. For example, criteria may be evaluated that determine an average brightness in an image is below a threshold and/or that determine a threshold percentage of an image is saturated (e.g., white) or zero (e.g., black).

Additionally, block 302 may include determining to operate in HDR mode with or without multiple frame rates. For example, criteria may be evaluated that determine an amount of motion in the scene of a previously-captured image frame, determine an amount of motion of the image capture device, and/or predict a current activity of the user and determine that the current activity is a high motion activity. When specified criteria are met, the image capture device may enter HDR mode with multiple frame rates, during which the operations of blocks 304, 306, 308, 310, and 312 may be performed and repeated until criteria indicate the camera should switch to another mode such as HDR mode with a single frame rate or SDR mode.

At block 304, a first camera is configured for image capture at a first frame rate. The camera may be configured by camera control, which may be a camera driver executing on the processor. The camera driver may cause the transmission of a command to the first camera 103 and/or cause the setting of a configuration register in the first camera 103 to correspond to a first image sensor configuration having a first frame rate. In some embodiments, the first frame rate may be 30 FPS. In some embodiments, the frame rate may be controlled through setting an explicit frame rate for the camera, such as by writing a value into a frame rate configuration register. In other embodiments, other parameters may be used to control an aspect of the camera that allows control similar to frame rate control, such as a configuration that changes the frame capture duration such that an implicit frame rate for the camera is controlled. In some embodiments, the camera application may send a Mode Update Bit that is read by the camera 103 and the ISP 112 pipeline to switch operation modes from 30 FPS to 60 FPS without performing a stream ON/OFF command such that the image data stream is not interrupted during the image sensor configuration.

At block 306, first image data is received from the first camera captured at the first frame rate. The image data may be received from the first camera 103 by an ISP 112, which performs processing on the data, such as in the image front end (IFE) 135 and the image post-processing engine (IPE) 136, to determine one or more image frames. The first image data may correspond to a first long image frame, such as image frame 202 in FIG. 2.

At block 308, the first camera is configured for image capture at a second frame rate. The camera may be configured by camera control 410, which may be a camera driver executing on the processor 104, causing the transmission of a command to the first camera 103 and/or causing the setting of a configuration register in the first camera 103 to correspond to a second image sensor configuration having a second frame rate. In some embodiments, the second frame rate may be 60 FPS or 90 FPS. In some embodiments, the frame rate may be controlled through setting an explicit frame rate for the camera, such as by writing a value into a frame rate configuration register. In other embodiments, other parameters may be used to control an aspect of the camera that allows control similar to frame rate control that changes the frame capture duration such that an implicit frame rate for the camera is controlled.

In some embodiments, the first and second image sensor configurations may have a same image resolution at the camera 103 and/or output data rate from the camera 103. For example, the image resolution may be decreased corresponding to an increase of the frame rate to maintain a constant data rate from the camera 103. In some embodiments, multiple frame rates are available for the second frame rate, in which the camera application may determine that if little or no motion exists in the scene (e.g., below a threshold level) the second frame rate is set to a lower frame rate (e.g., 60 FPS) for short exposure image frames, but if there is significant motion in the scene (e.g., above a threshold level), the second frame rate may be set to a higher frame rate (e.g., 90 FPS) for short exposure image frames.

At block 310, second image data is received from the first camera captured at the second frame rate. The image data may be received from the first camera 103 by an ISP 112, which performs processing on the data, such as in the image front end (IFE) 135 and the image post-processing engine (IPE) 136, to determine one or more image frames. The second image data may be used to determine a first short image frame and a second short image frame, such as image frames 204 and 206 in FIG. 2. In some embodiments, the ratio of short image frames captured at the second frame rate to long image frames captured at the first frame rate may correspond to a ratio of the first frame rate to the second frame rate. For example, when the first and second frame rates are 30 and 60 FPS, respectively, two short image frames may be captured for each long image frame captured. As another example, when the first and second frame rates are 30 and 90 FPS, respectively, three short image frames may be captured for each long image frame captured.

At block 312, at least one output image frame is determined based on the first image data received at block 306 and the second image data received at block 310. Output image frames may be determined by combining portions of one or more short image frames and one or more long image frames. FIG. 2 demonstrates one example technique for determining output image frames in which output image frame 232 (F1) may be determined as F1=Fuse(S12,L1) with S12=Fuse(S1,S2).

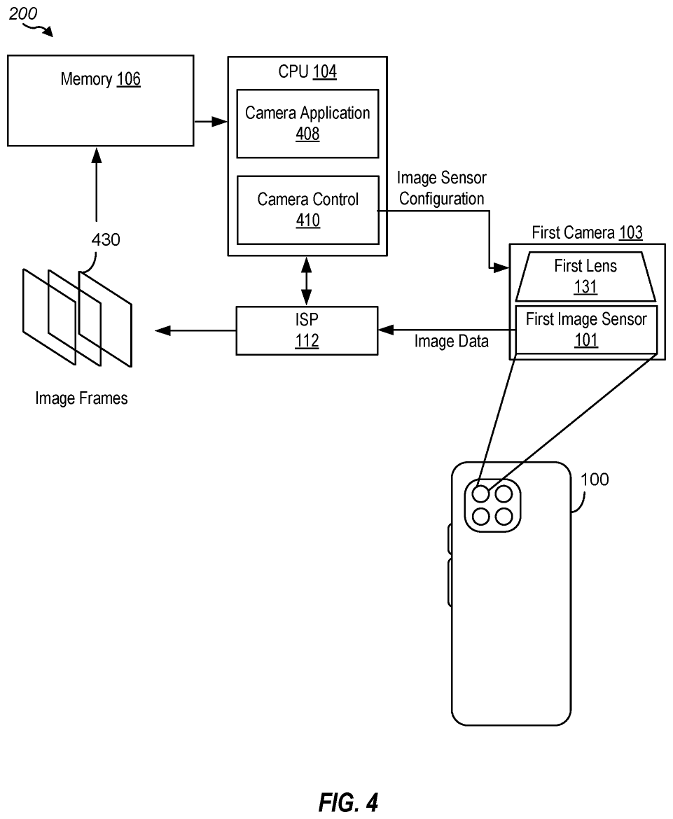

FIG. 4 shows a block diagram of an example device for performing an image capture operation in a device according to some embodiments of the disclosure. A processor 104 of system 400 may communicate with image signal processor (ISP) 112 through a bi-directional bus and/or separate control and data lines. The processor 104 may control camera 103 through camera control 410, such as for configuring the camera 103 through a driver executing on the processor 104. The configuration may include an image sensor configuration that specifies, for example, a frame rate for capturing image data. The camera 103 may obtain image data based on the image sensor configuration. For example, the processor 104 may execute a camera application 408 that determines to enter a HDR mode with multiple frame rates based on scene conditions and/or other data available in the device 100 (such as described with reference to FIG. 1). The camera application 408 may use camera control 410, such as a camera driver, to transmit an image sensor configuration specifying a first or second frame rate for the camera 103. The camera application 408 may access a camera driver in camera control 410 through an application programming interface (API) available in an operating system executed by the processor 104.

The camera 103 may operate the first image sensor 101 at the configured frame rate and/or other attributes of the first image sensor configuration to capture image data, which is transmitted to the ISP 112. The ISP 112 may perform processing in an IFE 135 and/or IPE 136 to determine image frames 430, which are stored in memory 106. The processor 104 may retrieve the image frames 430 to perform further processing, such as according to aspects of the processing described with reference to FIG. 2 and/or FIG. 3 to determine output image frames that are stored back in memory 106, output to a graphical display as a photograph preview in the camera application, and/or transmitting to another device through wireless communications. In some embodiments, the ISP 112 or another processing component (local to or remote from the device 100) may determine the output frames according to aspects of the processing described with reference to FIG. 2 and/or FIG. 3.

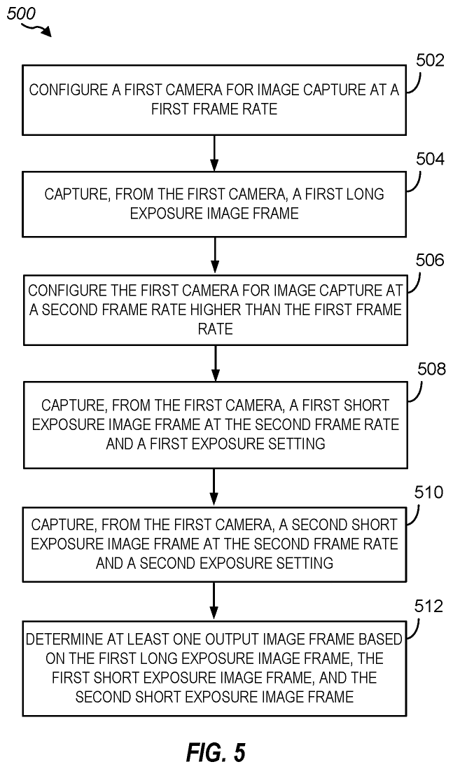

In some embodiments, the multiple short exposure image frames may be captured at different exposure settings (e.g., exposure duration, gain setting) to further improve dynamic range (DR). In such an operation, three image frames of different exposure settings are combined to determine an output image frame, which may provide increased dynamic range (DR) over combining image frames of two exposure settings. For example, the long exposure image frame may be captured at a first exposure setting, the first short exposure image frame may be captured at a second exposure setting, and the second short exposure image frame may be captured at a third exposure setting. An operation with different exposure settings for the short image frames is shown in FIG. 5.

FIG. 5 is a flow chart illustrating an example high dynamic range (HDR) operating mode for an image capture device to capture image frames with three exposure settings according to some embodiments of the disclosure. A method 500 incudes, at block 502, configuring a first camera for image capture at a first frame rate, and capturing a first long exposure image frame at the first frame rate at block 504. At block 506, the first camera is configured for image capture at a second frame rate. At block 508, a first short exposure image frame is captured at the first frame rate and a first exposure setting, and, at block 510, a second short exposure image frame is captured at the first frame rate and a second exposure setting. At block 512, output image frame(s) are determined from the first long exposure image frame and the first and second short exposure image frames, such as according to the processing described with reference to FIG. 2 and FIG. 3.

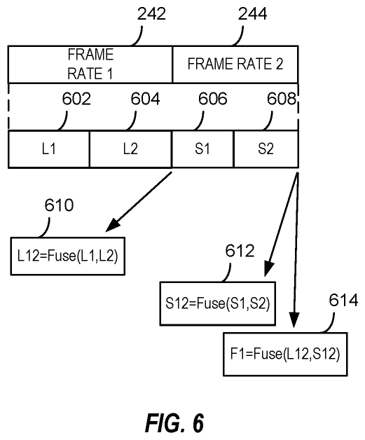

In some embodiments, multiple long exposure image frames may be captured at the first frame rate and combined to determine a first intermediate image frame that may subsequently be combined with a second intermediate image frame determined from combining the first and second short exposure image frames. FIG. 6 is a block diagram illustrating the use of frames captured at two different frame rates to perform HDR photography according to some embodiments of the disclosure. A first long image frame 602 (L1) and a second long image frame 604 (L2) are captured at the first frame rate 242. Subsequently, a first short image frame 606 (S1) and a second short image frame 608 (S2) are captured at the second frame rate 244. A first intermediate image frame 610 (L12) may be determined from a combination of the long image frames 602 and 604, such as from L12=Fuse(L1,L2). A second intermediate image frame 612 (S12) may be determined from a combination of the short image frames 606 and 608, such as from S12=Fuse(S1,S2). An output image frame 614 may be determined from the intermediate image frames 610 and 612, such as from F1=Fuse(L12,S12). In some embodiments, the image frames 602 and 604 may have different exposure durations and/or the image frames 606 and 608 may have different exposure durations. The output image frame 614 may be determined from up to four different exposure settings, which may increase dynamic range (DR) of the resulting photograph or video.

The image capture process of FIG. 6 may continue by repeating the capture operation, similar to FIG. 2. For example, long image frames L3 and L4 may be captured and combined into a third intermediate image frame (L34). The second and third intermediate image frames may be combined to form a second output image frame, F2=Fuse(S12,L34). Additional short image frames S3 and S4 may be captured and combined into a fourth intermediate image frame (S34). The third and fourth intermediate image frames may then be combined to form a third output image frame F3=Fuse(L34,S34).

In some embodiments, long and short image frames captured are fused together to determine a single output image frame using a dynamic anchor frame selection method. With dynamic anchor frame selection, the reference frame to be used during fusion is changed between a long exposure frame and a short exposure frame. The dynamic selection improves a smooth video sequence. For example, with reference to FIG. 2, a first short exposure frame 204 (S1) is fused with a second short exposure frame (S2) to determine an intermediate image frame 222 (S12). A long exposure frame 202 (L1) is then fused with S12 to determine a first output frame 232 (F1). When determining output image frame 232, the intermediate image frame S12 is used as the anchor frame. Next, long exposure frame 208 (L2) is fused with intermediate image frame 222 (S12) to determine a second output image frame (F2). When determining output image frame 234, the long exposure frame 208 (L2) is used as the anchor frame.

In some embodiments, HDR photography using images captures from different frame rates may be performed using two cameras. For example, long image frames may be captured from a first camera at a first frame rate and short image frames may be captured from a second camera at a second frame rate. As another example, long image frames may be captured from a first camera at a first frame rate, a first short image frame may be captured from a second camera at a second frame rate and a first exposure setting, and a second short image frame may be captured from a second camera at the second frame rate and a second exposure setting.

In one or more aspects, techniques for supporting image processing may include additional aspects, such as any single aspect or any combination of aspects described below or in connection with one or more other processes or devices described elsewhere herein. In a first aspect, supporting image processing and/or image capture operations may include an apparatus configured to switch frame rates between at least two frame rates during image capture to determine output image frames based on data captured each of the at least two frame rates. Additionally, the apparatus may perform or operate according to one or more aspects as described below. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the apparatus is further configured to perform steps including configuring a camera for image capture at a first frame rate; receiving, from the camera, first image data captured at the first frame rate; configuring the camera for image capture at a second frame rate higher than the first frame rate; receiving, from the camera, second image data captured at the second frame rate; and determining at least one output image frame based on the first image data and the second image data.

In a third aspect, in combination with one or more of the first aspect or the second aspect, the apparatus is further configured to perform steps including receiving, from the camera, third image data captured at the second frame rate, wherein the determining the at least one output image frame comprises: determining a first image frame based on the first image data; determining a second image frame based on the second image data and the third image data; and determining a first output image frame of the at least one output image frame based on the first image frame and the second image frame.

In a fourth aspect, in combination with one or more of the first aspect through the third aspect, the apparatus is further configured to perform steps including configuring the camera for image capture at the first frame rate; receiving, from the camera, fourth image data captured at the first frame rate, wherein the determining the at least one output image frame comprises: determining a third image frame based on the fourth image data, determining a second output image frame of the at least one output image frame based on the second image frame and the third image frame.

In a fifth aspect, in combination with one or more of the first aspect through the fourth aspect, determining the first output image frame is based on using the second image frame as an anchor frame, and determining the second output image frame is based on using the third output image frame as an anchor frame.

In a sixth aspect, in combination with one or more of the first aspect through the fifth aspect, a third exposure level for the third image data is different from a second exposure level for the second image data and a first exposure level for the first image data.

In a seventh aspect, in combination with one or more of the first aspect through the sixth aspect, the apparatus is further configured to perform steps including determining the second frame rate based on at least one characteristic of the first image data.

In an eighth aspect, in combination with one or more of the first aspect through the seventh aspect, determining the second frame rate comprises determining a motion value corresponding to motion in a scene represented by the first image data, wherein the determining the second frame rate is based on the motion value.

In a ninth aspect, in combination with one or more of the first aspect through the eighth aspect, an exposure duration for the first image data is an entire frame period at the first frame rate.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-6 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method, comprising:
configuring a camera for image capture at a first frame rate;
receiving, from the camera, first image data captured at the first frame rate;
configuring the camera for image capture at a second frame rate higher than the first frame rate;
receiving, from the camera, second image data captured at the second frame rate; and
determining at least one output image frame based on the first image data and the second image data.

2. The method of claim 1, further comprising:
receiving, from the camera, third image data captured at the second frame rate,
wherein the determining the at least one output image frame comprises:
determining a first image frame based on the first image data;
determining a second image frame based on the second image data and the third image data; and
determining a first output image frame of the at least one output image frame based on the first image frame and the second image frame.

3. The method of claim 2, further comprising:
configuring the camera for image capture at the first frame rate; and
receiving, from the camera, fourth image data captured at the first frame rate,
wherein the determining the at least one output image frame comprises:
determining a third image frame based on the fourth image data,
determining a second output image frame of the at least one output image frame based on the second image frame and the third image frame.

4. The method of claim 3, wherein:
determining the first output image frame is based on using the second image frame as an anchor frame, and
determining the second output image frame is based on using the third image frame as an anchor frame.

5. The method of claim 2, wherein a third exposure level for the third image data is different from a second exposure level for the second image data and a first exposure level for the first image data.

6. The method of claim 1, further comprising determining the second frame rate based on at least one characteristic of the first image data.

7. The method of claim 6, wherein determining the second frame rate comprises determining a motion value corresponding to motion in a scene represented by the first image data, wherein the determining the second frame rate is based on the motion value.

8. The method of claim 1, wherein an exposure duration for the first image data is an entire frame period at the first frame rate.

9. An apparatus, comprising:
a camera comprising an image sensor;
a memory;
a processor coupled to the memory and the camera and configured to receive image data from the image sensor, the processor configured to perform steps comprising:
configuring the camera for image capture at a first frame rate;
receiving, from the camera, first image data captured at the first frame rate;
configuring the camera for image capture at a second frame rate higher than the first frame rate;
receiving, from the camera, second image data captured at the second frame rate; and
determining at least one output image frame based on the first image data and the second image data.

10. The apparatus of claim 9, wherein the processor is further configured to perform steps comprising:
receiving, from the camera, third image data captured at the second frame rate,
wherein the determining the at least one output image frame comprises:
determining a first image frame based on the first image data;
determining a second image frame based on the second image data and the third image data; and
determining a first output image frame of the at least one output image frame based on the first image frame and the second image frame.

11. The apparatus of claim 10, wherein the processor is further configured to perform steps comprising:
configuring the camera for image capture at the first frame rate; and
receiving, from the camera, fourth image data captured at the first frame rate,
wherein the determining the at least one output image frame comprises:
determining a third image frame based on the fourth image data,
determining a second output image frame of the at least one output image frame based on the second image frame and the third image frame.

12. The apparatus of claim 11, wherein:
determining the first output image frame is based on using the second image frame as an anchor frame, and
determining the second output image frame is based on using the third image frame as an anchor frame.

13. The apparatus of claim 10, wherein a third exposure level for the third image data is different from a second exposure level for the second image data and a first exposure level for the first image data.

14. The apparatus of claim 9, wherein the processor is further configured to perform steps comprising:
determining the second frame rate based on at least one characteristic of the first image data.

15. The apparatus of claim 14, wherein determining the second frame rate comprises determining a motion value corresponding to motion in a scene represented by the first image data, wherein the determining the second frame rate is based on the motion value.

16. The apparatus of claim 9, wherein an exposure duration for the first image data is an entire frame period at the first frame rate.

17. A non-transitory computer-readable medium storing instructions that, when executed by a processor, cause the processor to perform operations comprising:
configuring a camera for image capture at a first frame rate;
receiving, from the camera, first image data captured at the first frame rate;
configuring the camera for image capture at a second frame rate higher than the first frame rate;
receiving, from the camera, second image data captured at the second frame rate; and
determining at least one output image frame based on the first image data and the second image data.

18. The non-transitory, computer-readable medium of claim 17, wherein the operations further include one or more operations comprising:
receiving, from the camera, third image data captured at the second frame rate,
wherein the determining the at least one output image frame comprises:
determining a first image frame based on the first image data;
determining a second image frame based on the second image data and the third image data; and
determining a first output image frame of the at least one output image frame based on the first image frame and the second image frame.

19. The non-transitory, computer-readable medium of claim 18, wherein the operations further include one or more operations comprising:
configuring the camera for image capture at the first frame rate; and
receiving, from the camera, fourth image data captured at the first frame rate,
wherein the determining the at least one output image frame comprises:
determining a third image frame based on the fourth image data,
determining a second output image frame of the at least one output image frame based on the second image frame and the third image frame.

20. The non-transitory, computer-readable medium of claim 19, wherein:
determining the first output image frame is based on using the second image frame as an anchor frame, and
determining the second output image frame is based on using the third image frame as an anchor frame.

21. The non-transitory, computer-readable medium of claim 18, wherein a third exposure level for the third image data is different from a second exposure level for the second image data and a first exposure level for the first image data.

22. The non-transitory, computer-readable medium of claim 17, wherein the operations further include one or more operations comprising:
determining the second frame rate based on at least one characteristic of the first image data.

23. The non-transitory, computer-readable medium of claim 22, wherein determining the second frame rate comprises determining a motion value corresponding to motion in a scene represented by the first image data, wherein the determining the second frame rate is based on the motion value.

24. The non-transitory, computer-readable medium of claim 17, wherein an exposure duration for the first image data is an entire frame period at the first frame rate.
